(19) United States
(12) Patent Application Publication
(10) Pub. No.: US 2011/0085802 A1
(43) Pub. Date: Apr. 14, 2011

(54) Polarization-multiplexed optical transmission

(76) Inventor: Pietro Bernasconi, Aberdeen, NJ (US)

(21) Appl. No.: 12/587,770

(22) Filed: Oct. 13, 2009

(51) Int. Cl. H04J 14/06

(52) U.S. Cl. 398/65

(57) ABSTRACT

In optical signal transmission, multiple sets of optical signals which contain data and are associated with at least two polarization states are multiplexed using a single arrayed waveguide grating (AWG). The resulting multiplexed signals are then polarization-multiplexed for transmission. In one embodiment, the AWG is provisioned in a unidirectional mode to multiplex the multiple sets of optical signals. In another embodiment, the AWG is provisioned in a bidirectional mode to multiplex the multiple sets of optical signals.

### FIELD OF THE INVENTION

The invention relates to a technique for optical communications and, more particularly, to a technique for transmission of polarization-multiplexed optical signals containing data.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

Wavelength division multiplexing (WDM) and signal coding, e.g., differential quadrature phase shifting keying (DQPSK), are commonly used in optical communications to efficiently utilize limited transmission bandwidth. The optical communication industry currently is in hot pursuit of 100 G optical technology whereby a transmitted wavelength can be used to carry information at a rate on the order of 100 Gbps. To realize the 100 G optical technology, use of a polarization-multiplexed scheme in addition to current optical transmission schemes, e.g., DQPSK and WDM, has been contemplated to increase the transmission spectral efficiency.

### BRIEF SUMMARY

The invention is premised upon a recognition that use of multiple optical multiplexers (e.g., arrayed waveguide gratings (AWGs)) in a typical transmission system to multiplex modulated optical signals of different polarizations is not desirable. Among other things, the multiple AWGs need to be spectrally aligned, e.g., to the same frequency (wavelength) grid, defined by a standard promulgated by the International Telecommunication Union (ITU) in order for the system to work properly. As a result, for example, two thermo-electric coolers (TECs) may be needed in the system to individually adjust the temperatures of the AWGs to tune and align their operating frequency ranges.

In accordance with an embodiment of the invention, only one passive optical device (e.g., an AWG) is used in an optical transmission system for multiplexing first and second sets of optical signals, which contain data and are associated with first and second polarization states, to provide first and second multiplexed signals, respectively. The first and second multiplexed signals are then transformed to be in the first and second polarization states (e.g., orthogonal to each other), respectively. The resulting signals are combined to form a combined signal for transmission. In that embodiment, among other advantages, only one optical multiplexer needs to be thermally controlled to achieve the proper spectral alignment.

In another embodiment, a passive optical device (e.g., an AWG) is configured to multiplex the first and second sets of optical signals in a bidirectional manner. The optical device has first and second sides thereof for receiving the optical signals in the first and second sets, respectively. The optical signals in the first set converge onto a first output on the second side of the device, thereby providing a first multiplexed signal at the first output. At the same time, the optical signals in the second set converge onto a second output on the first side of the device, thereby forming a second multiplexed signal at the second output. The first and second multiplexed signals are then polarization-multiplexed to form a combined signal for transmission.

### BRIEF DESCRIPTION OF THE DRAWINGS

FIG. 1 is a block diagram of a typical system for transmitting polarization multiplexed optical signals;

FIG. 2 is a block diagram of a system for transmitting polarization multiplexed optical signals in accordance with an embodiment of the invention;

FIG. 3 shows a multiplex section in one embodiment which may be used in the system of FIG. 2; and

FIG. 4 shows a multiplex section in another embodiment which may be used in the system of FIG. 2.

### DETAILED DESCRIPTION

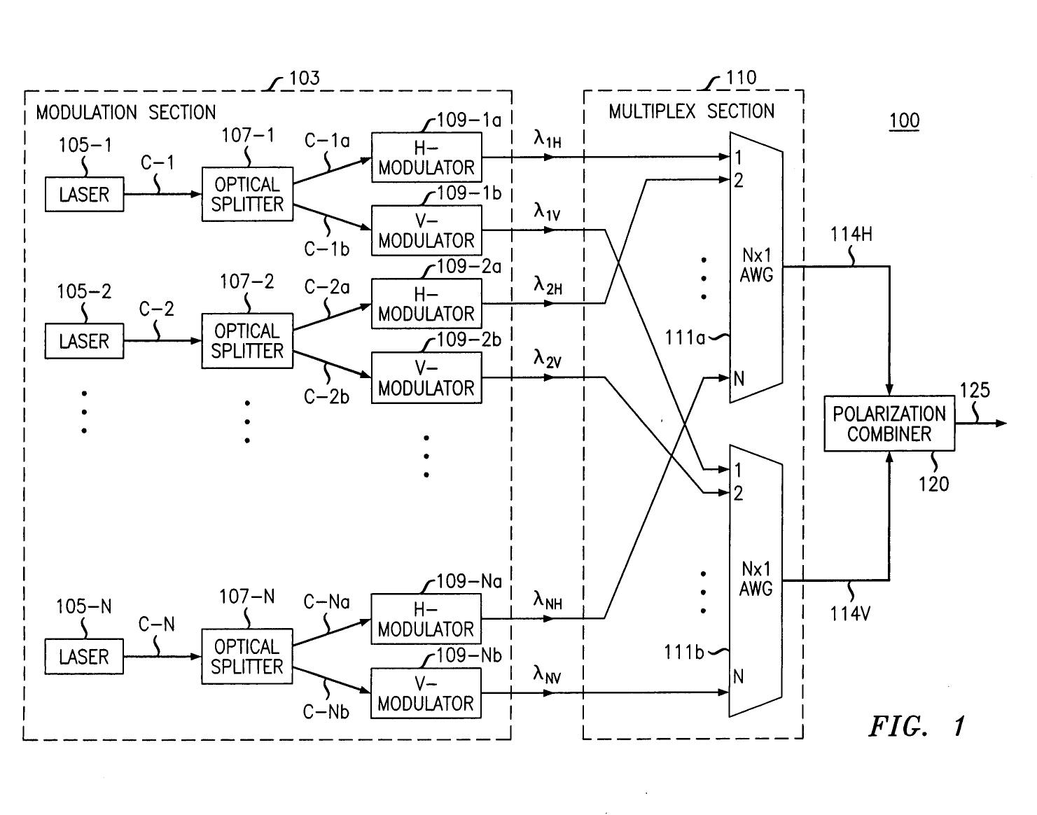

FIG. 1 shows a typical system 100 for multi-channel optical transmission using a polarization-multiplexed scheme. System 100 includes modulation section 103 wherein an array of N lasers 105-1 through 105-N generate polarized optical carrier signals C-1 through C-N of channel wavelengths λ₁ through λ_{N}, respectively, where N>1. In this instance, λₙ=λ₁+(n−1)Δλ, where the value of n ranges from 1 to N, and where λ₁ and Δλ, which represents spacing between the lasers' wavelengths, are predetermined. Typically, the carrier signals C-1 through C-N are linearly polarized. These carrier signals are power-split by optical splitters 107-1 through 107-N, respectively. The resulting signals from splitter 107-1, denoted C-1a and C-1b, are duplicate versions of C-1, albeit with reduced power. Similarly, the resulting signals from splitter 107-2, denoted C-2a and C-2b are duplicate versions of C-2; the resulting signals from splitter 107-3, denoted C-3a and C-3b are duplicate versions of C-3 . . . ; and so on and so forth. As fully disclosed hereinbelow, each pair of duplicate carrier signals C-na and C-nb will be modulated independently and will become two different polarization components to be merged by a polarization combiner to form the eventual polarization-multiplexed signal for transmission. For convenience, to distinguish between elements associated with the respective polarization components, an additional index H or V hereinafter may be used in their designation to indicate their association with the corresponding polarization component. For example, although duplicate carrier signals C-1a and C-1b have the same wavelength λ₁, for convenience their wavelengths are designated λ_{1H} and λ_{1V}, respectively. Similarly, the wavelengths of C-2a and C-2b are designated λ_{1H} and λ_{2V}, respectively, even though they are of same length; the wavelengths of C-3a and C-3b are designated λ_{3H} and λ_{3V}, respectively; . . . and so on and so forth.

Each pair of polarized carrier signals, C-na and C-nb (1≦n≦N), from an optical splitter 107-n is routed to a pair of modulators, H- and V-modulators 109-na and 109-nb, corresponding thereto. For example, H- and V-modulators 109-na and 109-nb may be nested Mach-Zehnder modulators. 2N streams of data (e.g., at a combined bit rate on the order of 100 GHz) are provided to the N pairs of modulators where the N pairs of carrier signals are modulated with the respective data streams, e.g., in accordance with a conventional DQPSK scheme. The modulated optical signals of λ_{nH} and λ_{nV} are fed to multiplex section 110 which includes two N×1 arrayed waveguide gratings (AWGs) denoted 111a and 111b, respectively, in accordance with a WDM scheme. Specifically, AWG 111a collects the modulated optical signals of λ_{nH} which are co-polarized, and AWG 111b collects the modulated optical signals of λ_{nV} which are co-polarized. As is well known, AWGs are passive optical signal multiplexers. The channel spacing of AWGs 111a and 111b corresponds to the spacing between the lasers' wavelengths, i.e. Δλ. Each set of modulated polarized optical signals is introduced into the corresponding AWG through its injection ports on its input side, where the signals in the set enter the sequentially-numbered injection ports in order of wavelength, e.g., with their wavelength increasing with the injection port number. That is, the modulated signal of λ_{nH} (λ_{nV}) enters input port n of AWG 111a (AWG 111b). The injection ports of AWG 111a are optically coupled to the collector output port thereof such that the incident modulated signals converge onto the collector output port, resulting in a multiplexed signal—polarized WDM signal 114H—emerging therefrom. Similarly, the modulated signals of λ_{nV} are multiplexed by AWG 111b to form polarized WDM signal 114V at its output port.

WDM signals 114H and 114V are polarization-multiplexed by polarization combiner 120, resulting in PM-DQPSK signal 125 to be transmitted through a transmission medium, e.g., an optical fiber. In a well known manner, polarization combiner 120 at the first stage may make the polarization states of WDM streams 114H and 114V nominally orthogonal to each other, for example, using polarization rotators such as retardation plates. Combiner 120 at the second stage may merge the two orthogonally polarized streams, for example, using a polarization beam combiner. Alternatively, a power combiner may be used at the second stage, however at the cost of additional power losses.

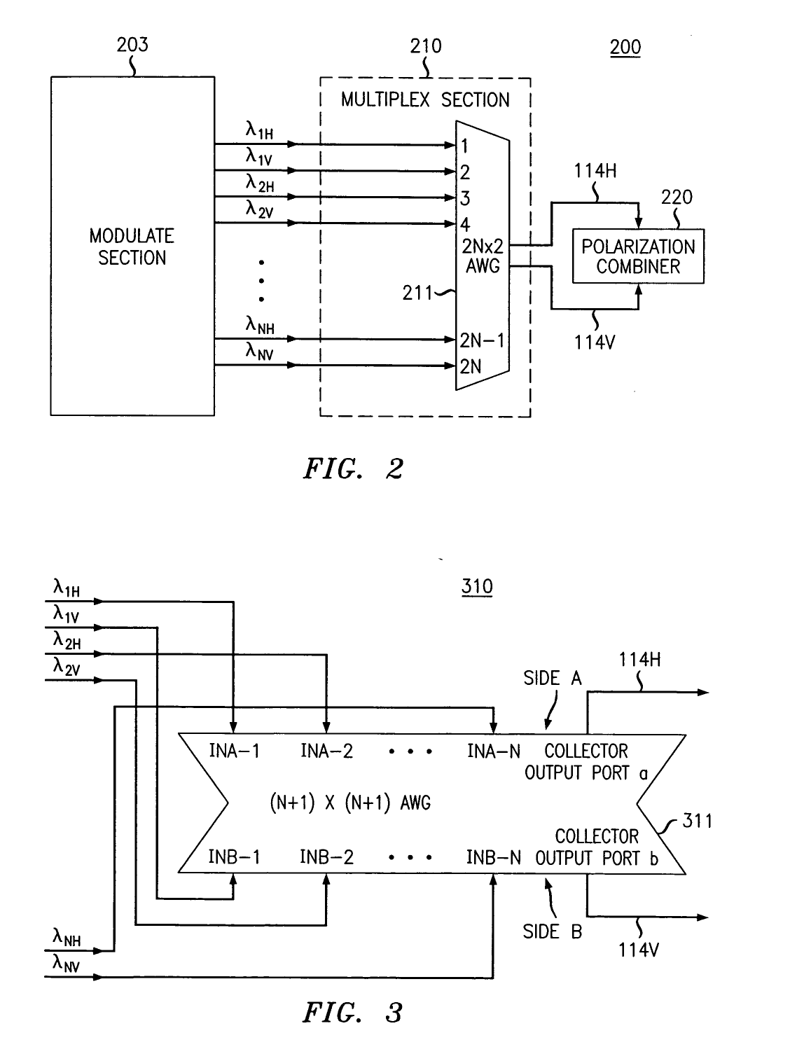

FIG. 2 illustrates optical transmission system 200 in accordance with an embodiment of the invention. System 200 in this instance includes modulation section 203 which may be identical to section 103 of system 100 described before. System 200 also includes multiplex section 210 which, however, is different from multiplex section 110 of system 100 in that multiplex section 210 comprises a single arrayed waveguide grating (AWG) which has multi-input ports and multi-output ports, e.g., 2N×2 AWG 211. By contrast, multiplex section 110 comprises multiple multiplexers, i.e., N×1 AWGs 111a and 111b each having multi-input ports and a single output port.

The invention is premised upon a recognition that use of the multiple AWGs for multiplexing the respective sets of modulated polarized signals as in system 100 is not desirable. For example, the multiple AWGs need to be spectrally aligned, e.g., to the same frequency (wavelength) grid, defined by a standard promulgated by the International Telecommunication Union (ITU) in order for the system to work properly. For example, the most common frequency (wavelength) grid that is used for dense WDM (DWDM) is defined relative to 193.1 THz and extends from about 191.7 THz to about 196.1 THz, with 100-GHz spacing (see ITU-T G.694.1). While defined in frequency, the grid is also often expressed in terms of wavelength, in which case its wavelength range is from about 1528 nm to about 1564 nm, with about 0.8-nm channel spacing. For practical purposes the grid is often extended to cover the range from about 186 THz to about 201 THz and subdivided to provide 50-GHz and 25-GHz spaced grids.

In system 100 two thermal control circuits, e.g., thermo-electric coolers (TECs), typically are used to individually adjust the temperatures of AWGs 111a and 111b to tune their operating frequency ranges. By contrast, only one such TEC needs to be used for AWG 211 in system 200, thereby obviating the otherwise duplication of the tuning effort and incurrence of the cost of an extra TEC. Thus, an advantage of using a single AWG 211 in system 200 is that the transmission passband of this multiplexer can be aligned with the lasers' wavelengths by controlling a single grating. In addition, AWG 211 is much more compact than AWG 111a and 111b combined, and thus may be more easily co-integrated with the signal sources and/or modulators in modulation section 203 to form a single chip.

In FIG. 2, the modulated polarized optical signals of λ_{nH} and λ_{nV} from section 203 are fed to multiplex section 210, where 1≦n≦N. The channel spacing between adjacent input ports of the AWG of AWG 211 in this instance corresponds to a fraction of the spacing between the lasers' wavelengths, which is conveniently set here to be one half of the wavelength channel spacing, i.e., ½ Δλ, to reduce transmission impairments to the signals traveling through the AWG. The modulated optical signals enter sequentially-numbered injection ports of AWG 211 on its input side in order of wavelength (e.g., with their wavelength increasing with the injection port number) and, at the same time, alternately with their H and V components. That is, the signals of λ_{1H} and λ_{1V} enter AWG 211 via its injection ports 1 and 2, respectively; the signals of λ_{2H} and λ_{2V} enter AWG 211 via its injection ports 3 and 4, respectively; . . . and the signals of λ_{NH} and λ_{NV} enter AWG 211 via its injection ports 2N−1 and 2N, respectively. In this instance, the odd-numbered injection ports (1, 3, . . . 2N−1) of AWG 211 are optically coupled to its output port 1 such that the incident signals of λ_{NH} converge onto collector output port 1, resulting in a multiplexed signal —polarized WDM signal 114H—emerging therefrom. Similarly, the modulated signals of λ_{nV} incident on the respective even-numbered injection ports (2, 4, . . . 2N) are multiplexed by AWG 211 to form polarized WDM signal 114V at its collector output port 2. WDM signals 114H and 114V are polarization-multiplexed by polarization combiner 220 (e.g, identical to combiner 120 of FIG. 1), resulting in PM-DQPSK signal 125 to be transmitted through a transmission medium, e.g., an optical fiber.

It is noteworthy that, unlike the signal paths leading to AWGs 111a and 111b in multiplex section 110 of FIG. 1, the signals paths leading to AWG 211 in section 210 of FIG. 2 do not cross one another. Since signal crossings may degrade signal integrity by introducing to the signals cross-talk, loss or other distortions, use of section 210 is advantageously conducive to monolithic integration thereof.

FIG. 3 shows multiplex section 310 which can be used as each instance of multiplex section 210 of system 200. As shown in FIG. 3, section 310 includes an (N+1)×(N+1) AWG (denoted 311), which operates in a bidirectional mode to multiplex the polarized optical signals in a bidirectional manner to be described. By contrast, each of AWGs 111a and 111b of FIG. 1, and AWG 211 of FIG. 2 operates in a unidirectional mode, where all polarized optical signals to be multiplexed are incident only on one side of the AWG (i.e., input side), and the resulting multiplexed signal(s) is emergent only on the other side thereof (i.e., output side).

Referring back to FIG. 3, AWG 311 has N+1 ports on each of its side A and side B. To perform multiplexing in a bidirectional manner, the first N ports on side A of AWG 311 are configured to be injection ports, denoted InA-1, InA-2, . . . and InA-N, for receiving the respective N modulated signals of λ_{nH} (1≦n≦N), e.g., from modulate section 103. These N modulated signals are incident on ports InA-1, InA-2, . . . and InA-N, respectively, in order from their shortest to longest wavelength. The first N ports on side B of AWG 311 similarly are configured to be N injection ports, denoted InB-1, InB-2, . . . and InB-N, for receiving the respective N moduated signals of λ_{nV}, e.g., from modulate section 103. These N modulated signals are incident on ports InB-1, InB-2, . . . and InB-N, respectively, in order from their shortest to longest wavelength. In this instance, all of the injection ports on side A of AWG 311 are optically coupled to the last, (N+1)^{th} port on its side B, referred to as “collector port b,” such that the N incident modulated signals λ_{nH} converge onto collector port b, resulting in the multiplexed signal WDM 114H emerging therefrom. Similarly, all of the injection ports on side B of AWG 311 are optically coupled to the last (N+1)^{th} port on its side A, referred to as “collector port a,” such that the N incident modulated signals λ_{nV} converge onto collector port a, resulting in the multiplexed signal WDM 114V emerging therefrom.

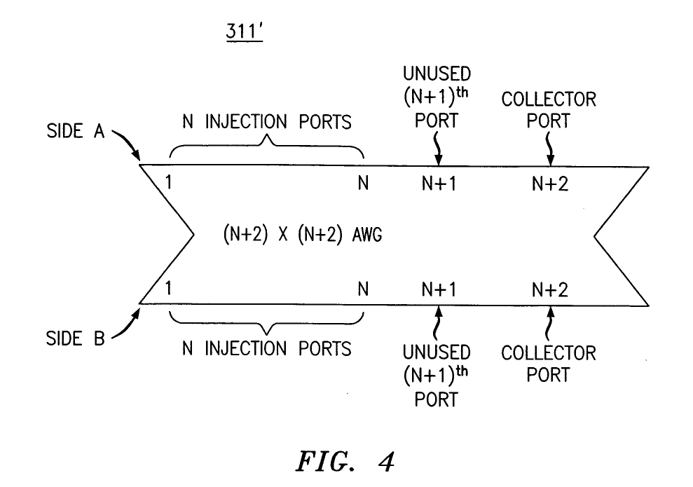

It should be noted at this point that in general, the size of an AWG is proportional to the number of ports on either side of the AWG, whichever number is larger. Thus, AWG 311, with each side having N+1 ports, is advantageously smaller than AWG 211, with its input side having 2N ports. As a result, AWG 311 is more conducive to co-integration with the signal sources and/or modulators, e.g., in modulation section 203 to form a single chip. In one embodiment, AWG 311 is selected to be used in multiplex section 310 because of its low level of optical crosstalk, less than 40-45 dB, possibly leaking from the injection ports on one side of the AWG to the injection ports on its other side, and feeding back to the modulators and the laser sources, thereby impairing their performance. In another embodiment, this optical crosstalk or leakage is further reduced by using a slightly larger AWG, denoted 311′, with an increased number (N+k, where k>1) of ports on each side thereof to better separate spatially the collector port from the injection ports. FIG. 4 illustrates one such AWG 311′ where k=2. As shown in FIG. 4, like AWG 311, AWG 311′ has injection ports occupy the first N ports on each side thereof. Unlike AWG 311, AWG 311′ has a collector port occupy the (N+2)^{th} port on each side thereof, with (N+1)^{th} port being unused to provide the additional spatial separation between the injection ports and the collector port.

The foregoing merely illustrates the principles of the invention. It will thus be appreciated that those skilled in the art will be able to devise numerous arrangements which embody the principles of the invention and are thus within its spirit and scope.

For example, in the disclosed embodiment, the collector ports of AWG 311 are arranged at an end of respective sides A and B so that WDM signals 114H and 114V may be conveniently fiber-tapped from a free end of the AWG, without interfering with any other connections (e.g. fibers or optical waveguides) leading to the injection ports. However, it will be appreciated that a person skilled in the art may design to have any port on each side of the AWG to be a collector port to suit his/her particular need.

In addition, the above embodiments disclose inventive techniques for polarization-multiplexing of signals modulated according to a DPQSK modulation scheme. It will be appreciated that a person skilled in the art may apply these inventive techniques to signals modulated according to a different modulation scheme, as well.

Finally, although system 200 and its components, as disclosed, are embodied in the form of various discrete functional blocks, such a system and components could equally well be embodied in an arrangement in which the functions of any one or more of those blocks or indeed, all of the functions thereof, are realized, for example, by one or more optical processors or devices.

What is claimed is:

1. An optical transmission system, comprising:
a plurality of elements for modulating at least first set and second set of optical signals with data, the optical signals in the first set being associated with a first polarization state, and the optical signals in the second set being associated with a second polarization state;
a single passive optical device for multiplexing the modulated optical signals in the first set to form a first multiplexed signal, and for multiplexing the modulated optical signals in the second set to form a second multiplexed signal; and
an optical processing unit for transforming the first multiplexed signal to be in the first polarization state, and for transforming the second multiplexed signal to be in the second polarization state, the first and second transformed multiplexed signals being combined to form a combined signal for transmission.

2. The system of claim 1 wherein the passive optical device comprises an arrayed waveguide grating (AWG).

3. The system of claim 2 wherein the AWG is configured to operate in a unidirectional mode where the modulated optical signals each are incident on a first side of the AWG, and the first and second multiplexed signals emerge from a second side thereof.

4. The system of claim 2 wherein the AWG includes a series of input ports for receiving the modulated optical signals in the first and second sets, respectively, those modulated optical signals in the first set entering every other input port in the series, and those modulated optical signals in the second set entering the remaining input ports in the series.

5. The system of claim 4 wherein the modulated optical signals in the first set enter corresponding input ports in the series in order of wavelength thereof.

6. The system of claim 2 wherein the AWG is configured to operate in a bidirectional mode where those modulated optical signals in the first set are incident on a first side of the AWG, and those modulated optical signals in the second set are incident on a second side thereof.

7. The system of claim 1 wherein the first and second sets of optical signals are modulated in accordance with a differential quadrature phase shifting keying (DQPSK) scheme.

8. An optical transmission system, comprising:
a passive optical device having first and second sides thereof for receiving at least first and second sets of optical signals, respectively, the first and second sets of optical signals containing data, the optical signals in the first set converging onto a first output on the second side of the device, thereby providing a first multiplexed signal at the first output, and the optical signals in the second set converging onto a second output on the first side of the device, thereby forming a second multiplexed signal at the second output; and
an optical processor for transforming the first and second multiplexed signals to be in first and second polarization states, respectively, the respective transformed signals being combined to form a combined signal for transmission.

9. The system of claim 8 wherein the passive optical device comprises an AWG.

10. The system of claim 8 wherein at least one of the optical signals in the first and second sets is a modulated optical carrier signal.

11. The system of claim 10 wherein the modulated optical carrier signal is formed by modulating, with data, an optical carrier signal provided from a laser source.

12. The system of claim 10 wherein the modulated optical carrier signal is formed by modulating, with data, an optical carrier signal in accordance with a DPQSK scheme.

13. The system of claim 9 wherein the AWG has a series of input ports on the first side, the optical signals in the first set entering the input ports in order of wavelength thereof.

14. The system of claim 13 wherein the second output of the AWG comprises an output port disposed at an end of the first side of the AWG separate from the input ports.

15. The system of claim 14 wherein the output port is separate from the input ports by one or more unused ports on the first side of the AWG.

16. An optical transmission system, comprising:
a passive optical device having a first set of input ports for receiving a first set of optical signals containing data, respectively, the optical signals in the first set being associated with a first polarization state, the first set of input ports being disposed on a first side of the device and being optically coupled to a first output port disposed on a second side of the device, thereby multiplexing the optical signals in the first set to provide a first multiplexed signal at the first output port, the passive optical device also having a second set of input ports for receiving a second set of optical signals containing data, the signals in the second set being associated with a second polarization state, the second set of input ports being disposed on the second side of the device and being optically coupled to a second output port disposed on the first side of the device, thereby multiplexing the optical signals in the second set to provide a second multiplexed signal at the second output port; and
an optical processor for transforming the first multiplexed signal to be in the first polarization state, and the second multiplexed signal to be in the second polarization state, the first and second transformed signals being combined to form a combined signal for transmission.

17. The system of claim 16 wherein the passive optical device comprises an AWG.

18. The system of claim 16 wherein the optical signals in the first set enter the first set of input ports in order of wavelength thereof.

19. The system of claim 17 wherein the second collector port is disposed at an end of the first side of the AWG separate from the first set of input ports.

20. The system of claim 18 wherein the second output port is separate from the first set of input ports by one or more unused ports on the first side of the AWG.
